(19) United States
(12) Patent Application Publication
(10) Pub. No.: US 2006/0274542 A1
(43) Pub. Date: Dec. 7, 2006

(54) Color blinking for domelights as a visibility enhancement technique

(75) Inventors: Rene Goulet, Ancienne-Lorette (CA); Claude Sylvain, Quebec City (CA); Pierre Provencher, Quebec City (CA)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: GE Security, Inc.

(21) Appl. No.: 11/144,008

(22) Filed: Jun. 3, 2005

(51) Int. Cl. B60Q 1/00

(52) U.S. Cl. 362/490

(57) ABSTRACT

A method and apparatus is disclosed for operating a multi-color LED domelight employing color blinking as a visibility enhancement technique. In the method, light is emitted having a first color, upon which light is intermittently emitted having a second color during the step of emitting light having a first color. All light is emitted through a common light-emitting surface defined by a domelight housing. The intermittent blinking of a different color light during or between the emission of the first color light enhances the visual perceptibility of the domelight device. In one embodiment, the first color is substantially red and the second color is substantially yellow. In another embodiment, the first color is substantially green and the second color is substantially magenta. In yet another embodiment, the first color is substantially blue and the second color is substantially white.

### CROSS-REFERENCE TO RELATED APPLICATIONS

None.

### FIELD OF THE INVENTION

The present invention relates generally to electronics and semiconductors. More particularly, the present invention relates to an apparatus and method for enhancing the visibility and perception of a light-emitting diode device.

### BACKGROUND OF THE INVENTION

This invention relates to “domelights,” which are small lights used to provide a visual signal or indicator, housed in a dome-like housing, shell or similar structure. The domelight may have one or more light-emitting elements, and may have any shape, although since the lights are commonly attached to planar surfaces, they may have a dome-like shape for practical purposes. Domelights may also include one or more of a number of differing light-emitting elements. One common such element is a light-emitting diode. A light emitting diode, or “LED,” is well-known in the field of electronics. Unlike ordinary incandescent bulbs, they do not have a filament but are illuminated solely by the movement of electrons in a semiconductor material. As such, they are good choices for use in a domelight, due to their comparatively low consumption of energy, low heat losses, long life, and consistency. A domelight may include more than one LED, while the color of light emitted by the LED may also vary according to the needs associated with the particular domelight.

In a hospital environment, systems utilize domelights to signal to a nurse or doctor or other staff member regarding a particular call or patient condition. The domelight is generally placed in a corridor or hallway and must be viewed from a long distance and a range of viewing angles. The domelights also have multiple light-emitting elements which have different colors. Each color indicates a particular call or condition as a signal to the hospital staff.

Because of the hectic pace and high traffic through a hospital corridor, it is often difficult to notice or become aware of a domelight, or a change in the color or condition of a domelight. Increasing the size of the domelight is generally not a good solution, for both economic and space-saving reasons. Increasing the luminance or brightness of the domelight is one solution, but this demands more energy and comes at a higher cost.

Accordingly, it is desirable to provide a method and apparatus that increases the visibility and noticeability of a domelight, without consuming additional energy or generating significant added costs.

### SUMMARY OF THE INVENTION

The foregoing needs are met, to a great extent, by the present invention, wherein in one aspect an apparatus is provided that in some embodiments increases the practical use of a domelight in a hospital environment, where multiple different colors of light are emitted from a domelight in an intermittent manner to attract attention to the domelight.

In accordance with one embodiment of the present invention, a method of operating a multi-color LED domelight is provided. Light is emitted having a first color. During the step of emitting light having a first color, light is intermittently emitted having a second color. Furthermore, all of the light is emitted through a common light-emitting surface defined by a domelight housing.

In accordance with another embodiment of the present invention, a method of operating a multi-color LED domelight is provided. Light having a first color and light having a second color are alternatingly emitted through a common light-emitting surface defined by a domelight housing. The light having the first color is emitted for a time substantially longer than the emitting of light having the second color.

In accordance with yet another embodiment of the present invention, a domelight for an LED device is provided. The domelight includes a housing body defining at least one light-emitting surface for transmission of light by an LED. The domelight further includes a multi-color LED element disposed within the housing body to emit light through the at least one light-emitting surface. The LED element is configured for emission of light having a first color and light having a second color. In this embodiment, the light having the second color is emitted intermittently with respect to the emission of light having the first color.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is an exterior view illustrating a domelight assembled according to one embodiment of the invention.

FIG. 2 is a schematic diagram of a domelight system arranged according to one embodiment of the invention.

FIG. 3a is a schematic illustration of the operation of a domelight according to one embodiment of the invention.

FIG. 3b is a schematic illustration of the operation of a domelight according to another embodiment of the invention.

### DETAILED DESCRIPTION

The invention will now be described with reference to the drawing figures, in which like reference numerals refer to like parts throughout. An embodiment in accordance with the present invention provides a method and apparatus for operating a multi-color LED domelight employing color blinking as a visibility enhancement technique. In the method, light is emitted having a first color, upon which light is intermittently emitted having a second color during the step of emitting light having a first color. All light is emitted through a common light-emitting surface defined by a domelight housing. The intermittent blinking of a different color light during or between the emission of the first color light enhances the visual perceptibility of the domelight device. In one embodiment, the first color is substantially red and the second color is substantially yellow. In another embodiment, the first color is substantially green and the second color is substantially magenta. In yet another embodiment, the first color is substantially blue and the second color is substantially white.

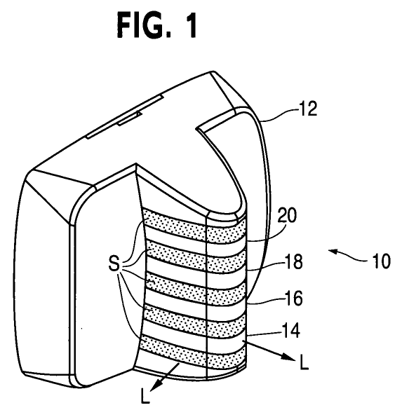

An embodiment of the present inventive apparatus is illustrated in FIG. 1. FIG. 1 shows a domelight 10 having a housing body 12 defining at least one light-emitting surface 14 for transmission of light by an LED. Additional light-emitting surfaces 16, 18, and 20 are also defined by the housing body 12 as shown. An LED element or LED assembly is contained inside the housing body 12 such that when light is emitted by the LED, it is directed out of the housing body 12 through the light-emitting surface 14 in the direction “L” as shown. Additional light emitted through surfaces 16 through 20 are directed similarly to the direction L, a different plane above or below the light emitted through surface 14. Each of the surfaces 14 through 20 may be the exterior of a light focusing lens or lens body, which are arranged in corresponding slots in openings defined by the domelight housing 12.

The shaded areas “S” disposed between the light-emitting surfaces 14 through 20 are light separators, which may optionally be included in the domelight 10 of the present invention. The domelight 10 shown in FIG. 1 is therefore configured to emit multiple beams of light from multiple light-emitting surfaces 14 through 20. However, the domelight 10 may alternatively include only one light-emitting surface, or many light-emitting surfaces, as the case may be, without deviating from the inventive principles of the present method and apparatus.

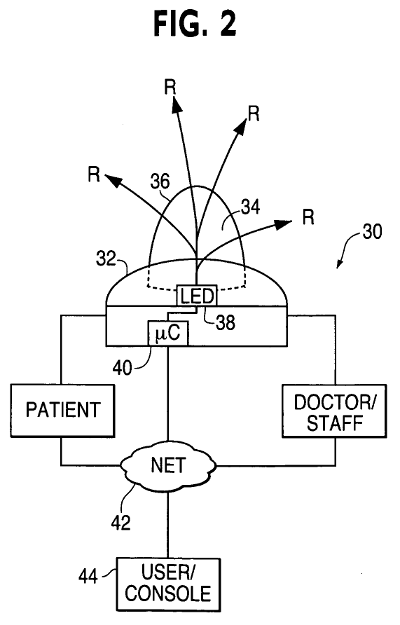

FIG. 2 is a schematic diagram of a domelight system 30 arranged according to one embodiment of the present invention. The system 30 includes one or more domelights 32 having at least one lens 34 which defines a light-emitting surface 36. The light is generated in the domelight 32 by one or more LED elements 38 which are disposed inside the domelight 32 or are placed to be mounted flush against a light-focusing element such as lens 34. The LED element 38 may be a multiple color emitting LED, such as a tri-color LED. The light emitted by the LED 38 will be focused and directed to be emitted by the domelight 32 generally along the arrows “R” as shown in FIG. 2.

The domelight 32 also includes at least one microcontroller 40 which controls the operation and emission of light by the LED element 38. The microcontroller may be any electronic component, such as a microprocesspor, which can process data as well as store data, the data being that which sets the pattern of light emission by the LED 38. The domelight 32, LED 38 and microcontroller 40 can all be coupled to a network 42, which in turn can be connected to a user console 44 remote from the domelight 32.

The microcontroller 40 can be integrated into the domelight unit 32, or can be remotely connected to the domelight 32 and its LED components via a network. In the latter case, a separate CPU or controller device can be used to control the domelight 32, wherein a control signal can be output and linked via cables and connectors directly to domelight 32. The same remote control could also be implemented using a wireless communications medium, such that the domelight 32 or a series of domelights 32 could be controlled by wireless signals, such as RF, infrared, microwave, or any other well-known wireless communications protocol.

In a hospital environment, the domelight 32 can be placed in any number of locations for use by patients and medical staff. A patient or doctor or other medical staff member can be directly connected to the domelight 32 or can be connected by means of a network connection through some network 42 installed in the hospital or other location employing the domelight 32. When used, the domelight 32 can emit one or more colors of light through one or more LED elements 38. The LED element 38 can have multiple individual light emitting elements or can be capable of emitting light in different colors through one element, as is well known in the art. Each color of light can be programmed to signify a particular medical condition or call relevant to the operation of the hospital or the providing of medical care in the facility. These particular conditions can be programmed for a particular color by entering data into the user console 44, or by entering data directly into the domelight 32 through the microcontroller 40.

In the present invention, to enhance the visual perceptibility of the domelight 32, it can be programmed to emit a first color of light through one of the LED elements 38. When a particular call or condition is desired to be displayed, so as to draw the attention of viewers of the domelight, the present invention calls for the emission of a second color of light in an intermittent fashion over or instead of the first color of light. The second color of light can be emitted in a regular, blinking pattern, or can be emitted in an irregular, intermittent fashion. Both colors of light will however be emitted through the same domelight 32 and through the same light emitting surface 36. Therefore, when a first color is being displayed, the addition of a second color blinking over the first color, for example, will cause the domelight 32 to be more noticeable, especially in an environment where ambient light, other corridor lights, window light, sunlight, and other visual impediments may be present which detracts from the practical use of the domelight.

Furthermore, it has been empirically observed and measured that certain combinations of light colors are more visually perceptible than others. The various combinations are set forth in Table 1 below:

TABLE 1

| Main Light Color | Intermittent Light Color |
|---|---|
| Red | Yellow |
| Green | Magenta |
| Blue | White |

The combinations set forth in Table 1 are but one example of light combinations which are in accordance with the principles of the present invention. It is readily understood that additional combinations may exist which give similar results to those set forth in Table 1.

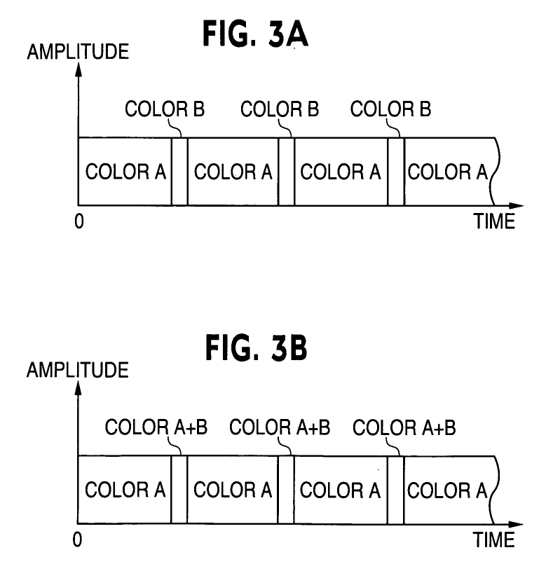

The patterns of intermittent light of a second color emitted with respect to light of a first color can vary, depending on the particular needs of the domelight environment. FIG. 3a is a schematic illustration of the operation of a domelight according to one embodiment of the invention. In FIG. 3a, light of a first color, COLOR A, can be periodically emitted while a regular, intermittent emission of light of a second color, COLOR B, takes place. This would be a fast blinking of COLOR B in between steady emission of COLOR A. The particular frequency or duration of the emission of COLOR B can be adjusted by the user, in part by programming the domelight 32 or microcontroller 40. For example, the blinking of COLOR B can be at a frequency of at least 1 Hz, and each pulse of COLOR B can last up to 0.25 seconds.

FIG. 3b is a schematic illustration of the operation of a domelight according to another embodiment of the invention. In this embodiment, instead of blinking COLOR B as an interruption of the emission of COLOR A, as in FIG. 3a, the second color of light is emitted in conjunction with COLOR A. Thus, COLOR A is emitted in a steady, constant amplitude and COLOR B is intermittently emitted in a regular or irregular manner to enhance the perceptibility of COLOR A. Again, the frequency or duration of pulses of COLOR B can vary widely. For example, the blinking of COLOR B can be at a frequency of at least 1 Hz, and each pulse of COLOR B can last up to 0.25 seconds. The amplitude of the emitted light is shown as constant in both FIG. 3a and FIG. 3b. This amplitude may also vary, such that when COLOR B is intermittently emitted the overall amplitude of light emitted by the domelight is increased.

Thus, by adding an intermittent emission of a second color of light through the same light-emitting surface of an LED domelight, the domelight can be more easily viewed and noticed by members of a hospital environment, especially in a fast-moving, dynamic environment with multiple visual cues and markers. This provides for a much more practical use of the domelight, one that is more likely to provide users with a reliable visual indicator or reminder.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method of operating a multi-color LED domelight, comprising:
emitting light having a first color; and
intermittently emitting light having a second color during the step of emitting light having a first color, wherein all light is emitted through a common light-emitting surface defined by a domelight housing.

2. The method of claim 1, wherein the first color is substantially red and the second color is substantially yellow.

3. The method of claim 1, wherein the first color is substantially green and the second color is substantially magenta.

4. The method of claim 1, wherein the first color is substantially blue and the second color is substantially white.

5. The method of claim 1, wherein the light having the second color is emitted at a frequency of at least 1 Hz, each emission having a duration of less than 0.25 seconds.

6. The method of claim 1, wherein all light is emitted by a dual color LED element.

7. The method of claim 1, wherein all light is emitted by a triple color LED element.

8. A method of operating a multi-color LED domelight, comprising:
alternatingly emitting light having a first color and light having a second color through a common light-emitting surface defined by a domelight housing, wherein the light having the first color is emitted for a time substantially longer than the emitting of light having the second color.

9. The method of claim 8, wherein the first color is substantially red and the second color is substantially yellow.

10. The method of claim 8, wherein the first color is substantially green and the second color is substantially magenta.

11. The method of claim 8, wherein the first color is substantially blue and the second color is substantially white.

12. The method of claim 8, wherein the light having the second color is emitted at a frequency of at least 1 Hz, each emission having a duration of less than 0.25 seconds.

13. The method of claim 8, wherein all light is emitted by a dual color LED element.

14. The method of claim 8, wherein all light is emitted by a triple color LED element.

15. A domelight for an LED device, comprising:
a housing body defining at least one light-emitting surface for transmission of light by an LED, and
a multi-color LED element disposed within the housing body to emit light through the at least one light-emitting surface, the element being configured for emission of light having a first color and light having a second color, the light having the second color being emitted intermittently with respect to the emission of light having the first color.

16. The domelight of claim 15, wherein the first color is substantially red and the second color is substantially yellow.

17. The domelight of claim 15, wherein the first color is substantially green and the second color is substantially magenta.

18. The domelight of claim 15, wherein the first color is substantially blue and the second color is substantially white.

19. The domelight of claim 15, wherein the light having the second color is emitted at a frequency of at least 1 Hz, each emission having a duration of less than 0.25 seconds.

20. The domelight of claim 15, wherein the multi-color LED element is a triple color LED element.
